(19) United States
(12) Patent Application Publication
(10) Pub. No.: US 2004/0007873 A1
(43) Pub. Date: Jan. 15, 2004

(54) Pipe mortar

(75) Inventors: Ralf-Joachim Herrmann, Senzig (DE); Henning von Seidlitz, Neuss (DE); Marold Elspass, Kaarst (DE); Rolf Bartolles, Korschenbroich (DE)

Correspondence Address: VENABLE, BAETJER, HOWARD AND CIVILETTI, LLP, P.O. BOX 34385, WASHINGTON, DC, 20043-9998, US

(73) Assignee: Rheinmetall W & M GmbH, Unterluss (DE)

(21) Appl. No.: 10/400,921

(22) Filed: Mar. 28, 2003

(30) Foreign Application Priority Data
Mar. 28, 2002 (DE) DE 102 13 928.8

(51) Int. Cl. F16L 33/18

(52) U.S. Cl. 285/355; 285/332.3

(57) ABSTRACT

To seal a pipe mortar, a sealing element (3, 6) is inserted between the pipe (1) and the base (2), with the element elastically balancing out the axial relative movements between the pipe (1) and the base (2). The sealing element (3) is preferably prestressed, with the gas pressure supporting the sealing effect. The sealing element (3, 6) can be a U-shaped or L-shaped steel ring. In the U-shaped sealing element (3), the legs (3.1) are axially prestressed to the extent that the sealing ring (3) and the pipe (1) or the base (2) are pressed together to produce an adequate seal. In the L-shaped sealing element (6), the inside leg (6.1) produces the gas-tight connection when the pipe (1) and the base (2) are screwed together. A sealing lips (6.2) of the sealing ring (6) elastically absorbs changes in length between the pipe and the base that occur during firing.

### CROSS REFERENCE TO RELATED APPLCIATION

This application claims the priority of German Patent Application DE 102 13 928.8 filed Mar. 28, 2002, which is incorporated herein by reference.

### BACKGROUND CF THE INVENTION

The invention relates to a seal for the pipe and base, or floor piece, of mortars or grenade launchers that operate in accordance with the front-loading principle.

Screwing the pipe and base or floor piece together creates an axial prestress force that brings axial annular surfaces into contact with one another, thus producing a seal. An additional copper ring is often used. Mortars that operate in accordance with the front-loading principle are typically placed on the ground for firing. Depending on the ground surface, various types of recoil travel and recoil acceleration may occur. If the ground surface is very soft, the recoil acceleration may cause the forces to be transmitted from the thread to increase to the point that the sealing surfaces separate from one another. The relatively low axial flexibility of the screw connection in particular contributes to this.

### SUMMARY OF THE INVENTION

It is the object of the invention to avoid the above drawback.

The object generally is achieved by a pipe mortar having a pipe and a base that are screwed together and between which axial relative movements occur during firing; and wherein a sealing element is inserted between the pipe and the base, and has an elastic deformity that balances out the axial relative movement between the pipe and the base.

The invention is based on the idea of inserting a sealing element between end surfaces of the pipe and the base for balancing out the axial relative movement between the pipe and the base through elastic deformation. According to the specifically disclosed embodiments, the seal is disposed to a portion of the end surface that extends to the interior surface of the pipe.

The sealing element is preferably prestressed. This prestress, supported by the gas pressure, produces the sealing effect.

Advantageous embodiments are disclosed.

The seal is produced according to and embodiment by a steel ring whose preferably U-shaped cross-sectional surface is open toward the inside or center of the ring and pipe. In the creation of the screw connection, the legs of the ring are axially prestressed to the extent that the sealing ring and the pipe or the base are pressed together to produce an adequate seal, even when maximum relative movements occur between the pipe and the floor piece or base. The opening of the sealing-ring profile toward the inside augments the sealing effect produced by the gas pressure acting in the sealing ring.

As an alternative, the sealing element can be formed as an L-shaped angle sealing ring L-shaped likewise comprising steel and can be pressed into the pipe and base, respectively, thereby forming a loose press-fit. The two legs of the ring, which are L-shaped, then produce the gas-tight connection when the pipe and the base are screwed together. Sealing lips of the ring elastically absorb changes in length between the pipe and the floor piece that occur in the X- and Y-axes during firing.

The above sealing elements create a seal between the pipe and the base or floor piece, which prevents gas leakage and associated washouts. Furthermore, the seal prevents the penetration of powder gases and severe contamination. The construction also facilitates disassembly.

The invention is described in detail by an exemplary embodiments shown in the Drawings.

### BRIEF DESCRIPTION OF THE DRAWING

FIG. 1 is a cutout representation of a sealing ring according to the invention between a pipe and a base or floor piece, with the ring being mounted in the base.

FIG. 2 is a further cutout representation of the sealing ring according to FIG. 1, with the ring being mounted in the pipe according to the invention.

FIG. 3 is a cutout representation of a further embodiment of a sealing ring between the pipe and the base.

### DETAILED DESCRIPTION OF THE INVENTION

The figures illustrate a pipe 1, a base or floor piece 2, sealing rings 3 and 6, and end surfaces 4 of the pipe 1 and of the base 2 of a mortar or grenade launcher, not shown in further detail.

The pipe 1 and the base 2 are screwed together in a known manner via the schematically shown screw connection.

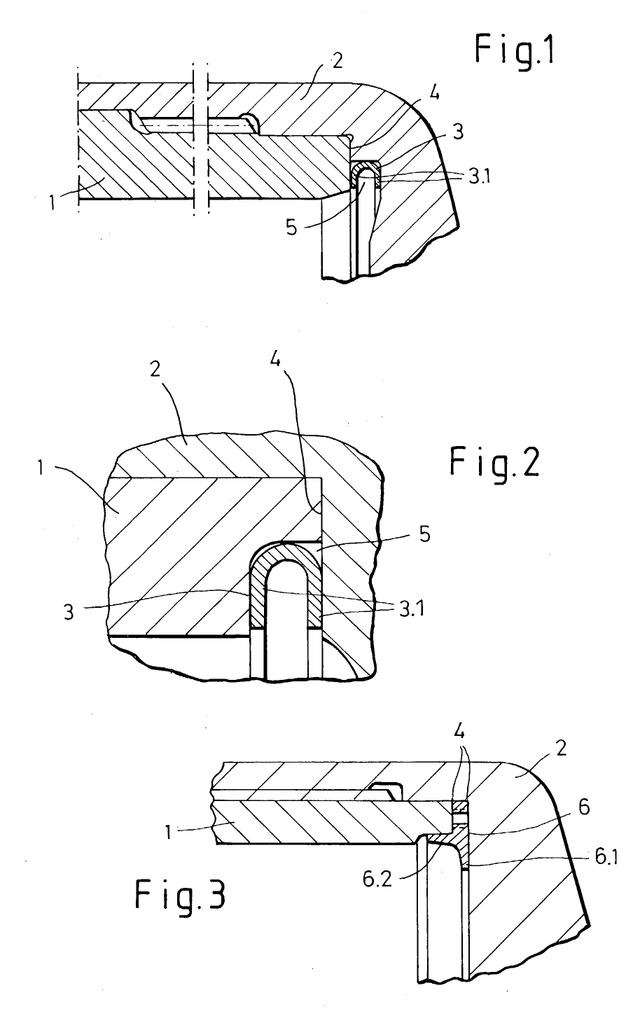

As shown in FIGS. 1 and 2, a sealing ring 3 having a U-shaped cross section that is toward the interior of the ring is positioned between portions of the end surfaces 4 of the pipes 3 and base 2 and extend to the interior surface of the pipe. Thus, the U-shaped ring 3 is also open to the interior of the pipe 1. The legs 3.1 of the U-shaped cross-section of the sealing ring 3 thus are compressed, and clamped together by the end surfaces 4 of the pipe 1 and the base 2. If the end surfaces 4 separate due to recoil acceleration, the seal is still effected between the elastically prestressed legs 3.1 of the sealing ring 3 and the pipe 1 and the base 2, respectively. The gas pressure in the pipe 1, against which the seal acts, dominates between the legs 3.1 of the sealing ring 3, and thus supports the sealing effect.

In the embodiment of FIG. 1 the sealing ring 3 is inserted into a groove 5 in the end surface of base 2. In the embodiment of FIG. 2, the sealing ring 3 is located in a groove 5 in the end surface of the pipe 1.

FIG. 3 shows a further embodiment of sealing ring 6, which is not U-shaped as in the case of FIGS. 1 and 2. The sealing ring 6 in this case is an angle ring of steel that is elastically clamped during firing and has legs 6.1 and 6.2 which result in an L-shaped cross section. This angle ring 6 is held between the end surfaces 4 of the pipe 1 and the base 2. The ring 6 has a radially inwardly facing leg 6.1 that forms an angle of about 1°. This inwardly facing leg 6.1 produces the gas-tight connection when the pipe 1 and the base 2 are screwed together. The ring 6 likewise has an axially extending sealing leg or lip 6.2 that elastically absorb changes in length between the pipe 1 and the base 2 that occur about the transverse (X) and longitudinal (Y)-axes.

The invention now being fully described, it will be apparent to one of ordinary skill in the art that many changes and modifications can be made thereto without departing from the spirit or scope of the invention as set forth herein.

What is claimed is:

1. A pipe mortar comprising a pipe and a base that are screwed together and, between which axial relative movements occur during firing; and a sealing element disposed between and end surfaces of the pipe and the base, and having an elastic deformity that balances out axial relative movement between the pipe and the base.

2. The pipe mortar according to claim 1, wherein the sealing element is disposed at a portion of the end surface extends to an interior surface of the pipe

3. The pipe mortar according to claim 1, wherein the sealing element is a steel ring having U-shaped cross-section that is open toward the inside of the ring and the pipe, with legs of the U-Shaped cross-section being axially prestressed during creation of the screw connection, to the extent that the sealing ring, the pipe and the base are pressed together to produce an adequate seal, even when maximum relative movements occur between the pipe and the base.

4. The pipe mortar according to claim 1, wherein the sealing element is an angle sealing ring with an L-shaped cross-section, and is pressed onto one of the pipe and the base with a loose press-fit, with one leg of the ring extending axially inwardly to produce a gas-tight connection, and with another leg of the ring extending axially in the form of a sealing lip to elastically absorb changes in length between the pipe and the base that occur in the transverse (X)- and axial (Y)-axes during firing.
